(19) United States
(12) Patent Application Publication
(10) Pub. No.: US 2007/0023152 A1
(43) Pub. Date: Feb. 1, 2007

(54) Roller blind with smooth pusher elements

(75) Inventors: Bernd Starzmann, Baltmannsweiler (DE); Herbert Walter, Ebersbach (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: BOS GmbH & Co. KG, Ostfildern (DE)

(21) Appl. No.: 11/488,222

(22) Filed: Jul. 18, 2006

(30) Foreign Application Priority Data
Jul. 29, 2005 (DE) 10 2005 036 318.0

(51) Int. Cl. B60J 1/20

(52) U.S. Cl. 160/370.22

(57) ABSTRACT

A roller blind assembly for windows of motor vehicles having roller blind and guide rails for guiding movement of the roller blind between extended and retracted positions. Pusher elements with a smooth outer side are protected from bending while being guided in the guide rails. The drive of these pusher elements is effected with the aid of a linear drive which is constructed with belts or cords for quiet operation.

### FIELD OF THE INVENTION

The present invention relates generally to window roller blinds for motor vehicles, and more particularly, to motor vehicle window roller blinds that are automatically extendable and retractable.

### BACKGROUND OF THE INVENTION

From DE 100 57 764, rear-window roller blinds for windows are known, which have a wind-up shaft rotatably mounted under a rear-seat shelf. One edge of the roller blind is fixed to the wind-up shaft. The other edge of the roller blind is connected to a pull-out profile. The ends of the pull-out profile are guided in guide rails, which are integrated, for example, in an inner lining of the C-column of the motor vehicle.

The roller blind is held under tension by means of a spring motor, which is connected to the wind-up shaft. The roller blind is pulled out with the aid of linear pusher elements, which are constructed in the form of a round toothed rack. The pusher elements include a cylindrical core, around which threads are wound in a spiral, so that a flexible toothed rack is produced with diagonal teeth all around. One of the two ends of the toothed rack is connected to end pieces of a pull-out profile guided in the guide rails. From here outwards, each pusher element runs through a chamber of the guide rail into a connecting tube, which opens at the other end in a gear housing of a geared motor. The output shaft of the geared motor carries a gear that meshes with the teeth of the pusher element for driving the pusher element.

Practical experience with such arrangements has shown that the threads on the pusher elements create noise when they slide over any joints of the connecting tube with the gear housing or the connecting tube with the guide rail. This noise is considered unacceptable.

### OBJECTS AND SUMMARY OF THE INVENTION

It is an object of the invention to provide an improved roller blind for motor vehicles which during operation, does not generate noise caused by the pusher elements.

In the novel roller blind, consistent with the prior art, a wind-up shaft is provided, to which one edge of the roller blind is attached. The contours of the roller blind outline correspond to a trapezoidal or rectangular approximation of the window to be shaded.

On the edge facing away from the wind-up shaft, there is a pull-out profile, which is guided, according to its configuration, at least on one end by means of a guide rail. A spring motor tensions the wind-up shaft in the direction of winding up the roller blind onto the wind-up shaft. In order to pull the roller blind away from the wind-up shaft against the force of the spring motor and to fix the blind in front of the vehicle window in question, there is at least one linear coupling element, which has a smooth outer surface. Because the surface is no longer toothed as in the prior art, but is instead smooth throughout, transitions and edges contacting the coupling element when it is pulled forward or retracted by the driving device can no longer generate rattling noises. Instead, the drive becomes whisper-quiet.

The coupling element is set in motion with the aid of a type of electromotive linear drive. For converting the linear drive, several variants can be used. First, it can be a screw drive, with a spindle nut being connected to the driven end of the pusher element. The other possibility is to rotate an endless belt about two deflection pulleys, one of which is driven electromotively. In this way, between the two pulleys there are two belt sections running parallel to each other. The driven end of the coupling element is connected to the associated belt section and thus can be moved back and forth linearly. This arrangement is an extraordinary space-saving arrangement and delivers two linear drives acting in opposite directions, so that two coupling elements for two guide rails can be driven in sync with the same stroke. The advantage of the belt rotating about two belt pulleys lies in the low spatial requirements in one direction. The spatial requirements in this direction are limited to the diameter of the belt pulleys, while the distance of the belt pulleys from each other is selected to be slightly larger than the required stroke of the roller blind. Transferred to the installation relationships, for example, for a rear window, this means that the linear drive can be integrated without additional measures in the area of the rear-seat shelf. At this location there is little space in the longitudinal direction of the vehicle, but there is much space in the transverse direction, where, without additional measures, the drive with endless belts can be accommodated.

The belt is preferably a toothed belt in order to guarantee slip-free driving. However, a smooth belt can also be used, which has the advantage that a certain degree of pinching protection can be automatically guaranteed by the resulting slippage. Also, for a smooth belt, when the two coupling elements are being driven, both coupling elements also are forced in sync with each other and cannot lose the synchronized state even if there is slippage.

For driving the coupling elements, a cord arrangement also can be used. Instead of letting an endless belt rotate about the two pulleys, a cord is used, whose ends are rigidly connected to each deflection pulley that is driven electromotively. Simultaneously, in terms of an end position, a corresponding number of windings accumulated on this deflection pulley, so that when the pulley is set to rotate in the opposite direction, the accumulated windings are gradually reduced, while in connection with the other cord end, the accumulated windings are gradually built up. In this way, a slip-free drive also is possible, when the two pusher elements are connected with their drive end to the sections running between the two pulleys. The arrangement becomes very robust and reliable when a cord composed of an aramid fiber or aramid threads is used for driving.

So that the driving forces can be transferred properly to the pusher element, a guide rail holding the pusher element preferably runs next to the straight section of the cord or the belt or the spindle nut. The guide rail contains a guide groove, whose cross section is made up of a groove chamber and a groove slot. The open width of the groove chamber is larger than the open width of the slot, whereby a bending-protected guidance of the pusher element is achieved when the diameter of the pusher element is smaller than the width of the groove slot.

For transferring force from the cord or belt to the pusher element, a carriage that runs in the groove chamber can be used. It is coupled via a connecting piece that projects through the slot to the belt or cord.

In the arrangement of the guide rail, for alignment of the belt, several variants come into play: the guide rail can run above or below the plane defined by the belt or along the path of the cord or it can be located next to the belt or the cord with reference to this geometry.

An especially stable guidance of the roller blind is achieved when the pull-out profile of the roller blind is guided on both ends. For this purpose there are two guide rails, which run on both sides of the tensioned roller blind.

The guide rail can also contain, in turn, a guide groove, whose geometry is similar to the geometry of the guide groove in the guide rail on the linear drive.

Other objects and advantages of the invention will become apparent upon reading the following detailed description and upon reference to the drawings, in which:

### BRIEF DESCRIPTION OF THE DRAWINGS

FIG. 1 is a broken open perspective of a rear area of a motor vehicle having a window roller blind in accordance with the invention;

FIG. 2 is a diagrammatic depiction of the actuating mechanism for moving a pull out rod or element of the illustrated roller blind to an extended pulled out position;

FIG. 3 is a detailed longitudinal section of a linear drive for the rear window roller blind shown in FIG. 2 which utilizes an endless belt; and

FIGS. 4 and 5 are perspectives of alternative embodiments of linear drives for the roller blind shown in FIG. 2 which utilize a cord drive.

While the invention is susceptible of various modifications and alternative constructions, certain illustrative embodiments thereof have been shown in the drawings and will be described below in detail. It should be understood, however, that there is no intention to limit the invention to the specific forms disclosed, but on the contrary, the intention is to cover all modifications, alternative constructions, and equivalents falling within the spirit and scope of the invention.

### DETAILED DESCRIPTION OF THE PREFERRED EMBODIMENTS

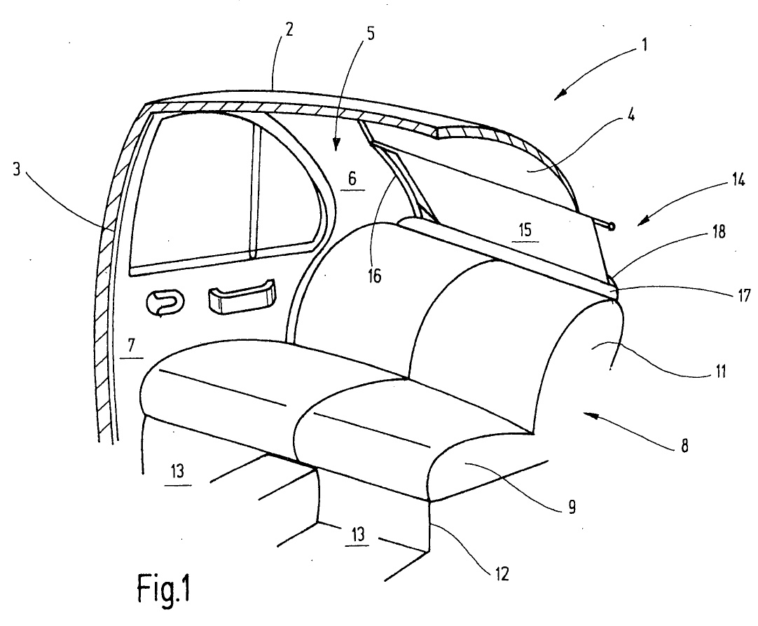

Referring now more particularly to FIG. 1, of the drawings, there is shown an illustrative motor vehicle car body section 1 having a rear window roller blind assembly 14 in accordance with the invention. FIG. 1 represents a cut-away rear area of a passenger car. The figure illustrates a view towards the right-side interior, which is the mirror image of the left-side interior. The view is simplified; for example, car body interior structures such as braces and attachment means are not shown because their illustration is not necessary for understanding the invention. The illustrated car-body section 1 has a roof 2, from which a B-column 3 leads downwardly at each side to a floor assembly of the vehicle. The roof 2 transitions at its rear edge into a rear window 4. On the sides, the rear window 4 ends at a C-column 5 located at a distance from the B-columns 3. The C-column 5 carries an inner lining 6.

Between the B-columns 3 and the C-column 5, rear right side doors 7 are hinged to the B-columns in a known way. At the height of the rear right side doors there is a rear-seat bench 8, which includes a seating surface 9 and a seat back 11. The seating surface 9 lies on a base surface 12 of the floor assembly in which foot spaces 13 are formed in front of the seating surface 9.

The rear window roller blind assembly 14 is mounted on the inside of the rear window 4. The rear-window roller blind assembly 14 is shown with its roller blind 15 partially extended between side guide rails 16 (one of which is shown). Each guide rail 16 begins at a rear-seat shelf 17 behind the rear seat back 11 and extends next to the side edge of the window. The guide rails may be made of plastic and may be integrated into the inner lining on the C-column 5. The illustrated rear-seat shelf 17 has a continuous pull-out slot 18 from which the roller blind 15 is drawn when it is extended.

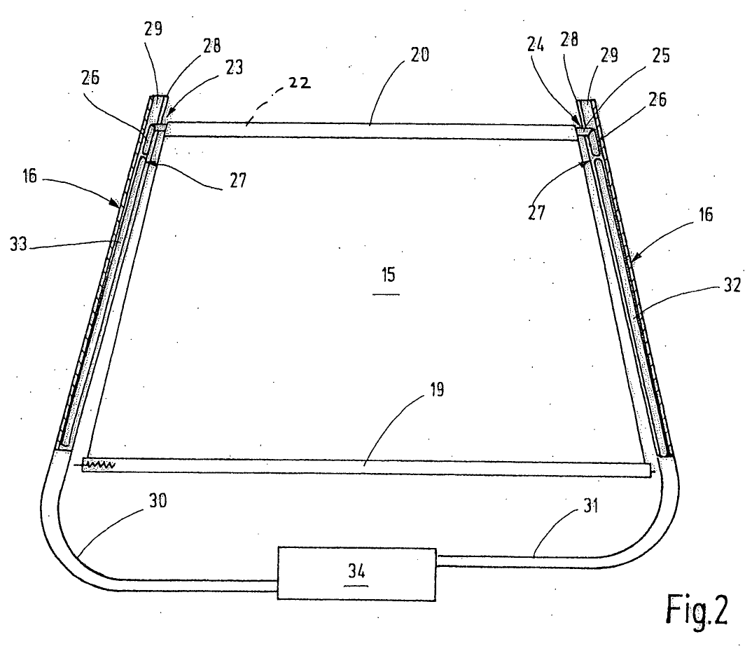

The basic construction of the rear-window roller blind 14 is depicted in FIG. 2. Beneath the rear-seat shelf 17, as can be seen from FIG. 2, a wind-up shaft 19 extends, which is rotatably mounted and to which the roller blind 15 is fixed at one edge. The wind-up shaft 19 is pre-tensioned with the aid of a spring motor 21 of a known type in the direction of winding up the roller blind 15 onto the wind-up shaft 19. For this purpose, an appropriate screw drive can be provided, which is anchored on one end on the car body and on the other end in the wind-up shaft 19.

The roller blind 15 has an approximately trapezoidal contour and is provided on its edge facing away from the wind-up shaft 19 with a tube-like sleeve 20. A pull-out profile or rod 22, in which end pieces 23, 24 are mounted in a telescoping way, is positioned through the tube-like sleeve 20. The end pieces 23, 24 have a throat section 25, which has a smaller diameter than a guide element 26 connected thereto. The guide element 26 has the shape of a short cylindrical section.

The guide elements 26 run in the guide rails 16, which are arranged mirror-inverted relative to each other and next to the two side edges of the rear window 4 and the tensioned roller blind 15. Each guide rail 16 contains a guide groove 27, whose cross-sectional profile is composed of a groove slot 28 and a groove chamber 29. The diameter of the circular groove chamber 29 corresponds to the diameter of the guide element 26, while the width of the groove slot 28, which is smaller than the diameter of the circular groove chamber 29, permits a passage of the throat section 25.

The lower end of each guide rail 16 is coupled via a guide tube 30, 31 to a linear drive 32. A pusher or coupling element 32 with a circular cross section runs in the groove chamber 29 of the right guide rail 16. The pusher or coupling element is largely compression-proof and is protected from bending while being guided with the aid of the guide rail and also the guide tube 31. In this way, both the compressive force and also the tensile force exerted by the linear drive 34 can be transmitted to the appropriate guide element 26. This is shown in the drawing with a small spacing in order to depict the differentiation between the guide element 26 and the pusher element 32, but actually the two components are connected to each other protected from tension and compression. In an analogous way, a pusher element 33 runs in the groove chamber 29 of the left guide rail 16 and the guide tube 30, so that the left end of the pull-out profile 20 is coupled to the linear drive 34 while being protected from tension and compression.

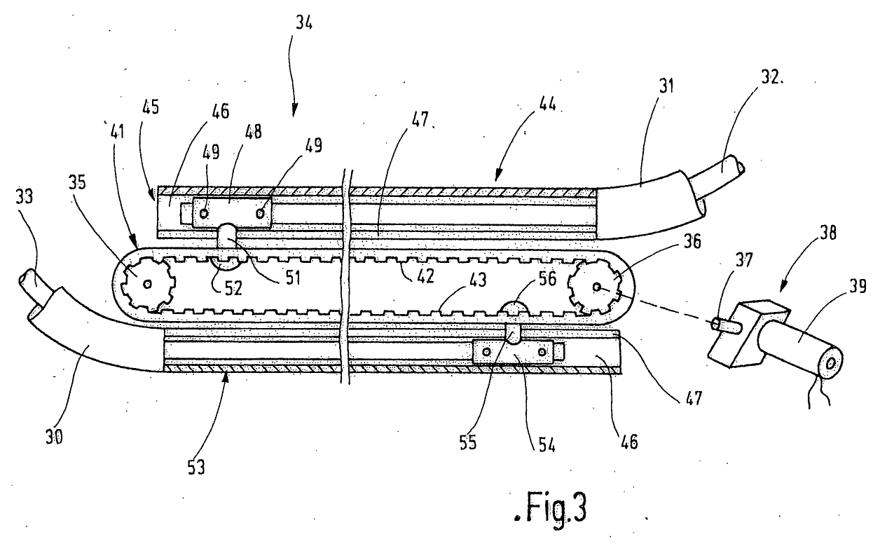

In accordance with the invention, the roller blind assembly has a linear drive 34 that operates quietly without the generation of noise caused by movement of the pusher elements. The illustrative linear drive 34, as depicted in FIG. 3, includes two axis-parallel toothed belt pulleys 35, 36, which are rotatably mounted and which have the same effective diameter. The toothed belt pulley 35 is mounted to be freely rotatable, while the toothed belt pulley 36 is mounted on and driven by an output shaft 37 of a geared motor 38. The geared motor 38 has a permanently excited DC motor 39, which can be selectively powered via the onboard power network of the motor vehicle for rotating the toothed belt pulley 36 in the clockwise or counterclockwise direction, depending on the polarity. An endless toothed belt 41, which is taut to some degree, runs around the two toothed belt pulleys 35, 36. In this way, two parallel belt sections 42, 43 are produced.

A guide rail 44, which is connected on the end to the guide tube 31, runs next to the belt section 42. The guide rail 44 has a guide groove 45, which defines a groove chamber 46 and a groove slot 47. The dimensions of the groove slot 47 and the groove chamber 46 correspond to the dimensions of the groove slot 28 and the groove chamber 29 of the guide rails 16 so that the end of the pusher or coupling element 32 in the guide rail 44 also is guided while being protected from bending and also cannot escape outwards through the groove slot 47.

A carriage 48, in which the end of the pusher or coupling element 32 is inserted and riveted with rivets 49, runs in the groove chamber 46. From the carriage 48, a throat section 51 extends outwardly toward the belt section 42 and is fixed there with a screw or a rivet 52, which extends through the belt section 42. Another guide rail 53, which has the same construction as the guide rail 44, runs next to the flat rear side of the belt section 43, and bears similar reference numerals as the guide rail 44. A carriage 54 with a throat section 55 runs in the groove chamber 46 of the guide rail 53. In the carriage 54, the end of the pusher or coupling element 33 is anchored, while the throat section 55 projects through the groove slot 47 and is connected to the belt section 43 by means of a screw or a rivet 56.

As can be seen from FIG. 3, the two guide rails 44 and 53 lie not only on different sides of the oval formed by the endless toothed belt 41, but they also point in opposite directions, i.e., from the upper guide rail 44, the connecting tube 31 extends towards the right, while from the lower guide rail 53, the connecting tube 30 extends towards the left. In this way, opposite movements can be generated with the same stroke.

The function of the arrangement is as follows:

In the retracted position, the roller blind 15 is largely wound onto the wind-up shaft 19 and is held under tension with the aid of the spring motor 21. FIG. 3 also shows the linear drive 34 in the retracted position of the roller blind. As can be seen, in this position, the carriage 48 is located next to the free end of the guide rail 44 and near the freely rotating toothed belt pulley 35. The same applies analogously to the carriage 54, which is also in the vicinity of the free end of the guide rail 53 and thus near the driven toothed belt pulley 36.

Starting from this end position, when the geared motor 38 is set in motion by activating the power supply voltage in the corresponding rotational direction so that the driven toothed belt pulley 36 rotates in the clockwise direction, as viewed in FIG. 3, the belt section 42 pulls the carriage 48 from the left to the right relative to FIG. 3, i.e., from the open end of the guide rail 44 in the direction towards the connecting tube 31. Furthermore, the toothed belt 41 driven in this way moves the carriage 44 in sync with the same magnitude from right to left relative to FIG. 3. The carriage 54 moves with the pusher or coupling element 33, which are immovably connected in the direction towards the toothed belt pulley 35. The pusher or coupling elements 32, 33 connected to the appropriate carriages 48, 54 are thus pushed forwards in the respective guide rail 16 and also with the same speed and magnitude. With their forward movement, they push the pull-out profile 20 in front of themselves and thus unwind the roller blind 15 from the wind-up shaft 19 against the effect of the spring motor 31. At the end, the roll-up shaft 15 is fixed in front of the rear window 4.

As will be understood, the spacing of the rotational axes of the two toothed belt pulleys 35, 36 must be sufficiently long. When the roller blind 15 reaches the completely extended position, neither the anchor of the carriage 48 on the toothed belt 41 nor the anchor of the carriage 54 on the toothed belt 51 is allowed to collide with one of the two belt pulleys 35, 36. Thus, at the end of the stroke, the carriage 48 is next to the belt pulley 36, while the carriage 54 is adjacent to the belt pulley 35.

For retraction, the geared motor 38 is activated in the opposite rotational direction so that now a tensile force is transmitted via the belt section 43 to the two carriages 48, 54. According to the rotational movement of the belt 41 about the two belt pulleys 35, 36, the pusher or coupling elements 32, 33 are pulled back from the guide rails 16. They move together with the guide pieces 26 connected rigidly to their respective ends. Simultaneous with the movement of the pull-out profile 20 in the direction towards the wind-up shaft 19, the roller blind 15 is wound onto the wind-up shaft 19 by the spring motor 21.

The foregoing arrangement has the important advantage that the two pusher or coupling elements 32, 33 are completely smooth on their outer peripheral surfaces. In this way, loud noises are not generated when the two pusher or coupling elements 32, 33 run over any edges that unavoidably exist due to the connection between the guide tubes 30, 31 to the guide rails 16 or 44 and 53 during retraction or extension. For the practical embodiment of the illustrated roller blind, other joints can be produced in the guide devices for the pusher or coupling elements 32, 33 because the guide tubes 30, 31 which are shown as continuous in FIG. 2, can be composed of several different sections due to reasons specific to their assembly.

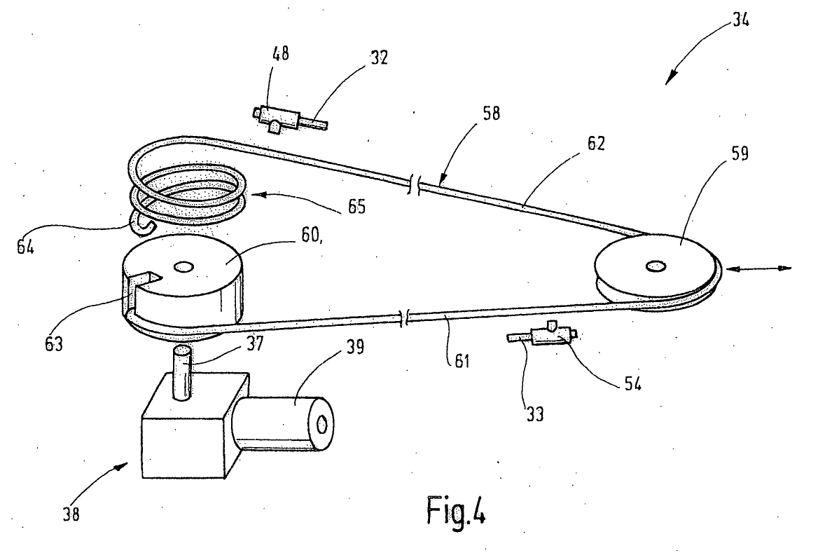

An alternative embodiment for the linear drive 34 is shown in FIG. 4. The primary difference concerns the use of a cord 58 instead of the toothed belt 41. FIG. 4 is restricted to the illustration of the drive for the cord 58 because the arrangement of the guide rails 54, 53 is the same as shown in FIG. 3. In this embodiment, a cord deflection pulley 59 is provided. A cord driving pulley 60 is mounted axis-parallel relative to this deflection pulley. The cord driving pulley 60 is rotatably driven by the output shaft 37 of the geared motor 38 of the same construction as explained in connection with FIG. 3.

An end of the cord 58 in this case is fixed to the cord driving pulley 60 in an attachment slot. It leads from the cord driving pulley 60 to the cord deflection pulley 59 around this back to the cord driving pulley 60. Between the run-in point of the cord 58 and the cord end 63, which is, in turn, anchored in the anchor slot 62, the cord 68 forms an accumulation 64 of windings. In other words, the cord 58 lies between the run-in point and the anchor in several windings around the cord driving pulley 61. The length of the accumulated cord corresponds at least to the axis spacing between the cord deflection pulley 59 and the cord driving pulley 60.

When this type of cord drive is set in motion, such as when the cord driving pulley 60 is rotated in the clockwise direction, as depicted in FIG. 4, by the geared motor 38, an increasing number of cord sections 61 are wound onto the cord driving pulley 60. Simultaneously, the cord unwinds from the cord driving pulley 60 in the region of the cord section 61, i.e., the accumulation 65 of windings gradually decreases, while windings accumulate on the cord driving pulley 60 in connection with the cord section 61.

With the two cord sections 61, 62, as explained in connection with FIG. 3, the corresponding carriages 48, 54, respectively, are connected, as shown in FIG. 4. Because the two cord sections 61, 62 can move in opposite directions in the same way as the belt sections 42, 43, for the corresponding attachment of the two carriages 48, 54, the necessary opposite movement of the pusher and coupling elements 32, 33 can be generated as explained above. The drive according to FIG. 4 is slip-free. An especially reliable arrangement is obtained when the cord is composed of aramid fiber, for example, Kevlar. It also can be a mono-filament.

It can be seen from the figures that the two corresponding ends of the pusher or coupling elements 32, 33 adjacent to the linear drive 34 are connected via the toothed belt 41 or the cord 58 with constant spacing. Consequently, slippage generated between the driving motor 38 and the belt 41 or the cord 58 does not adversely affect the function. Thus, instead of the positive-lock drive as shown in FIGS. 3 and 4, a drive with slippage also can be used.

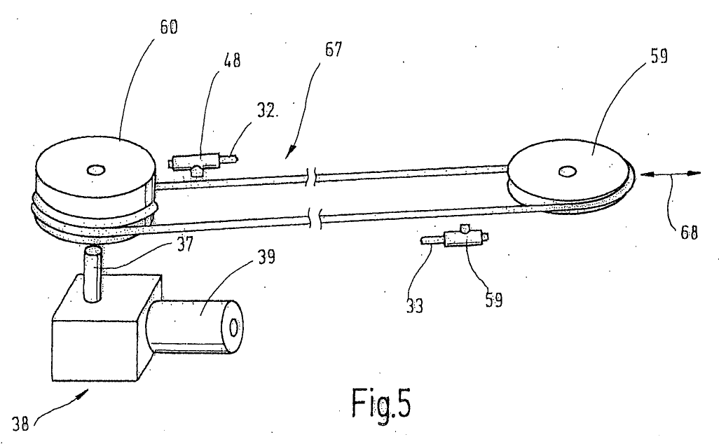

FIG. 5 shows such a drive. Instead of the cord 58 with the two open ends, which are anchored to the cord driving pulley 60, a closed cord ring 67 is used. The cord ring lies around the cord deflection pulley 59, while it forms one or two complete windings on the cord driving pulley 60. The cord driving pulley 60 thus acts similarly to a winch, so that it is possible, in turn, to set the carriages 48, 54 fixed to the two cable sections 61, 62 in motion. To insure proper operation of the arrangement according to FIG. 5, the cord pulley 59 is mounted for movement in the direction parallel to the double arrow 68 for keeping the cord ring 67 constantly under sufficient tension.

From the foregoing, it can been seen that the invention has been described in connection with a rear-window roller blind with two guide rails. The illustrated driving concept with a linear drive and smooth pusher and coupling elements can also be used for side windows since the position of the guide rails within the vehicle is independent of the inventive concept. In particular, the drive can also be used in connection with vehicle sunroofs and/or side or front windows. The use of roller blinds on side windows and sunroofs is shown, for example, in DE 100 40 624, the disclosure of which is incorporated herein by reference. In each case the roller blind includes guide rails, with pusher or pressing elements with a smooth outer side which run in guide rails guided and protected from bending. The drive of the pusher or pressing elements is effected with the aid of a linear drive, which is constructed with belts or cords, the operation of which is quiet.

1. A roller blind assembly (14) for motor vehicles comprising:
a wind-up shaft (19) supported for rotational movement,
a roller blind (15) connected at one end to the wind-up shaft (19),
a spring motor (21) coupled to the wind-up shaft for rotating the wind-up shaft (19) in a roller blade wind-up direction;
a pull-out profile (20) fixed to an end of the roller blind (15) opposite the wind-up shaft (19),
at least one guide rail (16) mounted adjacent the roller blind (15) for guiding movement of at least one end of the pull-out profile (20),
at least one elongated linear pusher element (32, 33) which interacts with the end of the pull-out profile (20) guided in the guide rail (16) for moving the pull-out profile (20) and the roller blind (15) connected hereto at least in the direction of pulling out the roller blind (15) from the wind-up shaft (19),
said pusher element (32, 33) having a smooth outer peripheral surface along its elongated length, and
an electromotive linear drive (34) acting on the pusher element (32, 33) for moving the pusher element (32, 33) in the direction of pulling out of the roller blind (15) from the wind-up shaft (19).

2. The roller blind assembly of claim 1 in which an end of the pusher element (32, 33) driven by said electromotive linear drive (34) is protected from bending over a movement stroke necessary for pulling the roller blind (15) out from the wind-up shaft (19).

3. The roller blind assembly of claim 1 in which said linear drive element (34) defines a straight guide groove (45), a carriage (48, 54) supported for movement in said straight guide groove (45), and said pusher element (32, 33) having an end opposite that acting on the pull-out profile (22) connected to the carriage (48, 54).

4. The roller blind assembly of claim 3 in which said carriage (48, 54) has an actuating projection (51, 55) extending outwardly of the linear drive guide groove (45).

5. The roller blind assembly of claim 3 in which said linear drive guide groove (45) has a cross section that defines a groove chamber (46) and a groove slot (47), with the width of the groove chamber being greater than the open width of the groove slot (47).

6. The roller blind assembly of claim 1 in which said linear drive (34) includes an endless belt (41) moveable around at least two pulleys (35, 36), one of which is power driven.

7. The roller blind assembly of claim 1 in which said linear drive includes a closed ring cord (67) which is trained for movement about at least two pulleys (59, 60) at least one of which is power driven.

8. The roller blind assembly of claim 1 in which said linear drive (34) includes at least two rotatably mounted pulleys (59, 60), one of which is electromotively driven and the other of which is freely rotatable, a cord (58) trained for movement around said pulleys (59, 60), and said cord (58) having ends connected to the electromotively driven pulley (60) free from slippage.

9. The roller blind assembly of claim 6 in which an end of the pusher element (32, 33) away from the pullout profile (20) is coupled to said belt.

10. The roller blind assembly of claim 7 in which an end of said pusher element (32, 33) away from the pullout profile (20) is coupled to said cord.

11. The roller blind assembly of claim 7 in which said cord (58, 67) is formed by an aramid thread.

12. The roller blind assembly of claim 6 in which one of the pulleys other than the power driven pulley is mounted for free rotation, and said freely rotatable pulley is mounted for translational movement transverse to the rotational axes of the pulleys.

13. The roller blind assembly of claim 1 including two guide rails (16) which are located on opposite sides of the roller blind (15).

14. The roller blind assembly of claim 13 in which the spacing of the guide rails (16) changes, starting from the wind-up shaft (19) in a direction toward each other at locations away from the wind-up shaft (19).

15. The roller blind assembly of claim 1 in which said guide rail (16) includes a guide groove (27) includes cross-sectional profile defines a groove chamber (29) and a groove slot (28), with the open width of the groove chamber (29) being greater than the open width of the slot (28).

16. The roller blind assembly of claim 15 in which the groove chamber (29) has a circular cross section.

17. The roller blind assembly of claim 15 in which the pull-out profile (20) include end pieces (23, 24) with end guide elements (26) whose cross-sectional profile is adapted to the cross-sectional profile of the groove chamber (29).

18. The roller blind assembly of claim 1 in which the pusher element (32, 33) is guided in a groove chamber (29) of a guide rail (16).

19. The roller blind assembly of claim 17 in which the linear pusher element (32, 33) is coupled to an end guide element (26) of the pull-out profile (22).
